(19) United States
(12) Patent Application Publication
(10) Pub. No.: US 2012/0257426 A1
(43) Pub. Date: Oct. 11, 2012

(54) AC Adapter With Automatic Built-In Power Switch

(75) Inventor: Arthur L. Serrano, West Hills, CA (US)

(73) Assignee: EVER WIN INTERNATIONAL CORPORATION, City of Industry, CA (US)

(21) Appl. No.: 13/084,246

(22) Filed: Apr. 11, 2011

(51) Int. Cl. H02M 1/36

(52) U.S. Cl. 363/49

(57) ABSTRACT

The AC adapter with automatic built-in power switch comprises of an AC power supply circuit, an AC control circuit, and a monitoring circuit. The monitoring circuit further comprises of a standby power supply, a microcontroller, a circuit for device detection, and a current monitor circuit. The AC power supply circuit is electrically connected to the alternating current source and converts the alternating current to direct current for charging the rechargeable battery of an electronic device. The AC control circuit acts as a switch to turn the AC power supply on and off. The monitor circuit detects whether an electronic device is connected to the adapter and also whether the charging process is completed.

### BACKGROUND

1. Field of Invention

The present invention relates generally to alternating current adapters. More specifically, the present invention relates to an electrical adapter that converts alternating current to direct current and outputs through a coaxial plug to charge an electronic device such as a notebook computer.

2. Description of Related Art

Most modern electronic devices consume substantial amount of electrical energy to perform its complex and multiple functions. The electrical energy is generally provided by a battery enclosed within the electronic device. The battery may be a disposable battery but more commonly, it is a rechargeable battery. The rechargeable battery must be recharged with a direct current source when it is depleted.

Adapters are commonly used to convert household 110V alternating current to direct current to power and recharge electronic devices. The rechargeable battery in an electronic device is recharged by electrically connecting it to the direct current output of the adapter. The adapters are often left connected to the alternating current source even when it is not being used to recharge a rechargeable battery. Although the adapter is not being used to recharge a rechargeable battery, it nevertheless still consumes electrical power while being connected to the alternating current source. The user must either manually unplug the adapter from the alternating current source or activate a manual switch to completely shut off the consumption of electrical power by the adapter.

Additionally, when the electronic device has finished charging its rechargeable battery, yet remains connected to the adapter, the adapter continues to attempt to charge the electronic device and consume electrical power.

Therefore, there exists an unfulfilled need to be able to conveniently eliminate this constant waste of electrical power by the adapter. A convenient means, particularly one that functions automatically without requiring any manual intervention from the user, is lacking to easily conserve the electrical power that is being wasted by the adapter.

### BRIEF SUMMARY OF THE INVENTION

The present invention is a convenient and automatic means to automatically and completely shut off the electrical power consumption by an alternating current (AC) to direct current (DC) adapter when it is not being used to recharge an electronic device. The AC adapter with automatic built in power switch may remain plugged into an alternating current source yet consumes no power when no electronic device is connected to it or when the electronic device that is connected to it has finished charging.

The AC adapter with automatic built in power switch comprises of an AC power supply circuit, an AC control circuit, and a monitoring circuit. The monitoring circuit further comprises of a standby power supply, a microcontroller, a circuit for device detection, and a current monitor circuit. The AC power supply circuit is electrically connected to the alternating current source and converts the alternating current to direct current for charging the rechargeable battery of an electronic device. The AC control circuit, a solid state relay, acts as a switch to turn the AC power supply on and off. The monitor circuit detects whether an electronic device is connected to the adapter and also whether the charging process is completed.

### BRIEF DESCRIPTION OF THE DRAWINGS

FIG. 1a shows the complete schematic, with the components identified with labels, of the preferred embodiment of the AC adapter with automatic built-in power switch.

FIG. 1b shows the same complete schematic, with the values of the components identified, of the preferred embodiment of the AC adapter with automatic built-in power switch.

FIG. 2 shows the 95 W AC power supply circuit.

FIG. 3 shows the AC control circuit.

FIG. 4 shows the standby power supply.

FIG. 5 shows the microcontroller.

FIG. 6 shows the current monitor circuit.

FIG. 7 shows an alternative embodiment of the AC adapter with automatic built-in power switch for the low wattage AC supply using primary side sensing.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

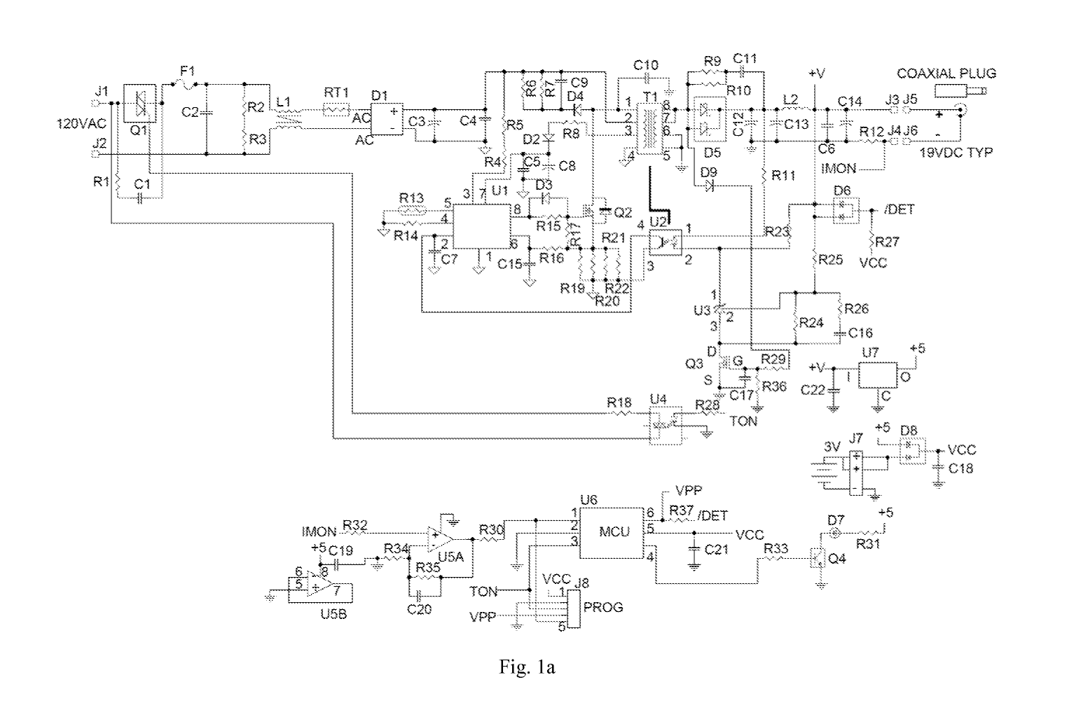

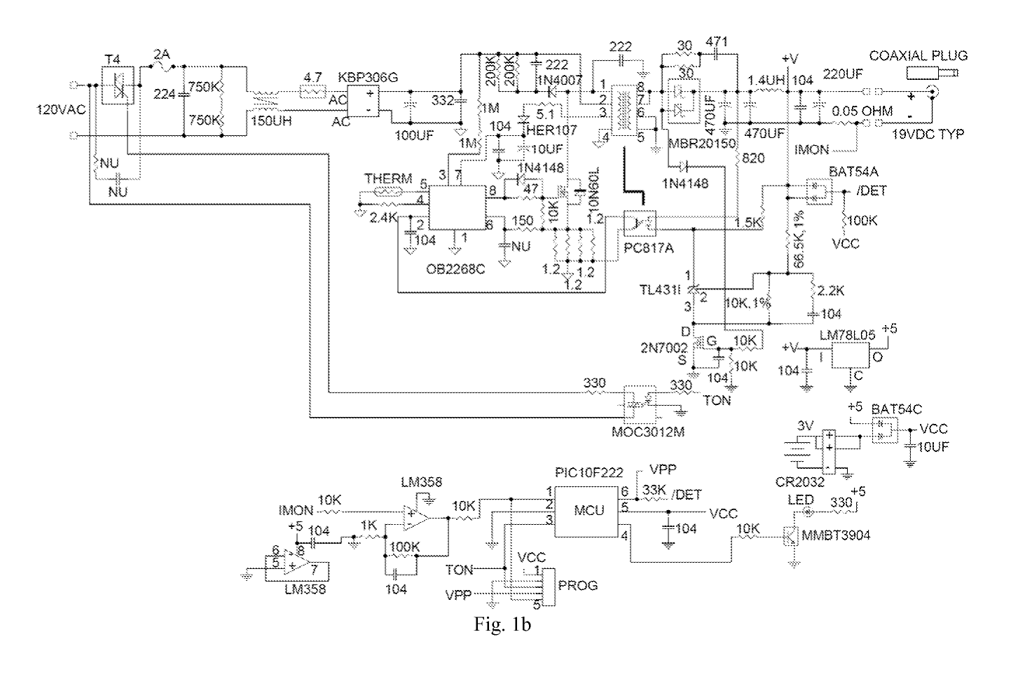

FIGS. 1a and 1b show the complete schematic of the preferred embodiment of the AC adapter with automatic built-in power switch. The AC adapter with automatic built-in power switch comprises of an alternating current (AC) power supply circuit, an AC control circuit, and a monitoring circuit. The monitoring circuit further comprises of a standby power supply, a microcontroller, a circuit for device detection, and a current monitor circuit.

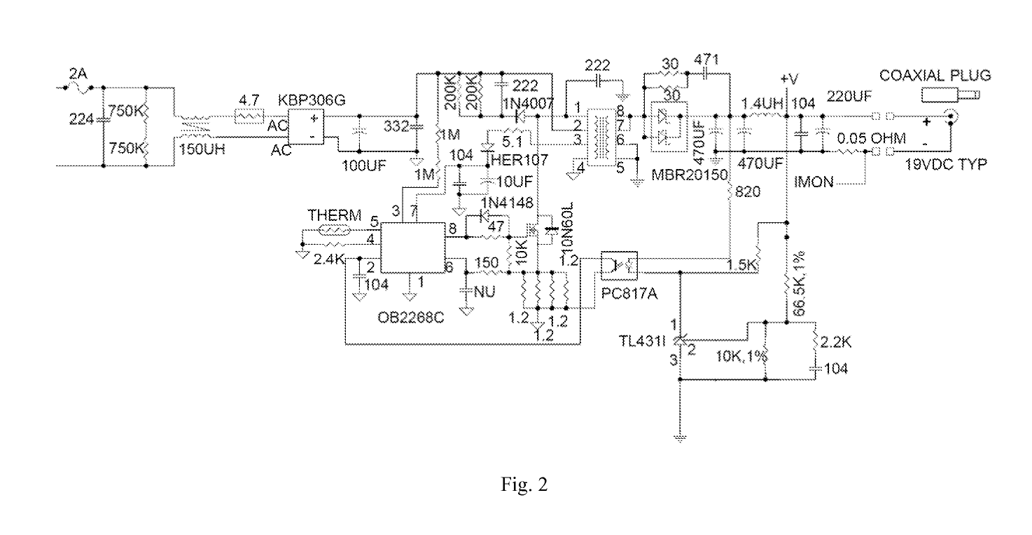

FIG. 2 shows the AC power supply circuit. The preferred embodiment of the present invention uses a 95 W AC power supply circuit. This AC power supply circuit design is well known in the art. It electrically connects to an AC power source and outputs 19V direct current (DC) and can supply as much as 5A. FIG. 2 represents a 95 W example and can be replaced by any other similar AC power supply circuit design well known in the art.

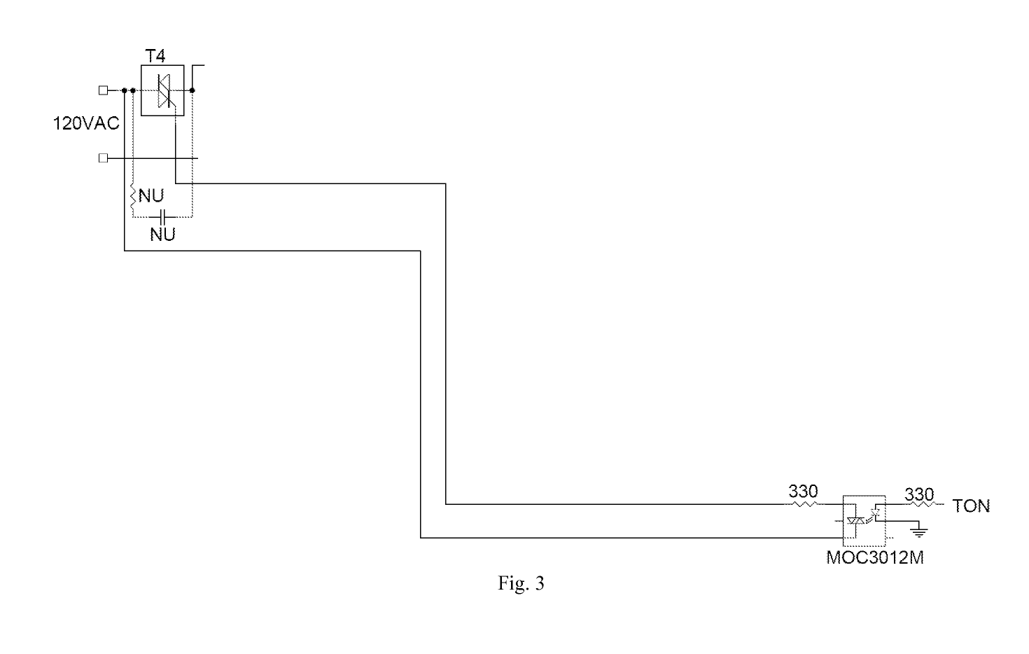

FIG. 3 shows the control circuit on the AC side of power supply. This function is generally referred to as a “solid state relay.” It comprises a high sensitivity TRIAC (Q1) placed in series with the 120V AC input. This acts as a switch between the one side of the AC line and the power supply circuit. The other side of the 120V AC line is directly connected to the power supply. The TRIAC is turned on by an optically isolated TRIAC driver U4. Underwriters Laboratories Inc. (UL) regulations dictate that in an AC power supply adapter there must be isolation between the high voltage 120V AC side and the low voltage DC side that the user comes in contact with. U4 is controlled by a logic signal (TON) from the microcontroller. When TON is low (0V), U4 is turned off which causes the TRIAC switch to open up, turning off the AC power supply completely. When TON is high (+3V to +5V) U4 is turned on causing the TRIAC switch to close, applying power to the AC power supply circuit.

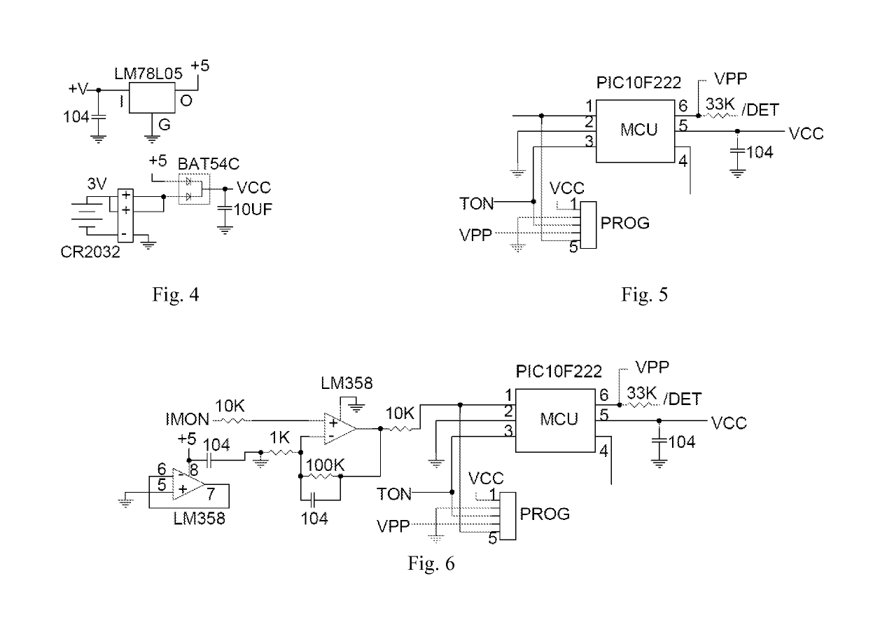

FIG. 4 shows the standby power supply portion of the monitor circuit. Power to the microcontroller/monitor circuit is preferably provided by a 3V lithium coin cell battery when the power supply is turned off. However, any other suitable battery may be used. The standby power drain from this battery while the AC is off is approximately 100 nanoamps. Once the AC power is turned on and the AC supply outputs 5V, the power to the monitor/microcontroller (VCC) is provided by the 5V supply and not the battery. Section 1 of the dual diode D8 is reversed biased when the 5V is conducting through section 2, thus blocking current from the coin cell battery. This will minimize the use of the power from the coin cell battery and extend the useful life of the coin cell battery. When the AC supply is turned on, the 19V (+V) output is regulated by U7 to +5V to provide power to the microcontroller and the monitor circuit.

FIG. 5 shows the microcontroller portion of the monitor circuit. A very simple microcontroller (MCU) is used in the preferred embodiment. U6 is a Microchip PIC 10F222. Any other similar microcontroller can be used for this purpose. In the preferred embodiment, the MCU uses a detector circuit to sense that a device is connected to the adapter coaxial plug to turn the AC power on. J8 is used for in-circuit programming of the MCU and has no direct relevance to the circuit functions described herein.

The type of AC power supply as illustrated in FIG. 2 uses an optical coupler based feedback loop to maintain voltage regulation. This optical coupler (U2) in combination with reference U3 and resistors R11, R23, R24, R26, and C16 form the feedback loop which maintains the output voltage at the regulated level (+19V DC in this embodiment). The present invention modifies this circuit by disconnecting the ground line from U3-3 and R24. The reason for this will be explained later. This invention also adds diode D6 and pull-up resistor R27 to VCC.

When the AC power is off (the TRIAC Q1 is turned off), D5-1 and D5-3 will be at zero volt potential. The voltage will also be zero at the cathode of D9. R27 will pull-up the +V line to VCC (+3V). If the ground return of U3 and R24 were not disconnected, the +V voltage would be loaded by the DC resistance path of R11, R23, R25, R24, and U3 to ground. This would load the /DET signal to near zero volts. To prevent this, the gate of FET Q3 is connected via R29 to D9 cathode which is at zero volts. This turns off the FET (Q3) and lifts the ground from U3-3 and R24.

When a device is connected to the barrel plug (coaxial connector), R27 (100K) is easily loaded to ground by the device load. This makes /DET low and the MCU wakes up. The MCU then sets TON to 1 which turns on U4 which in turn triggers the TRIAC and the AC power is turned on. The transformer output is activated. D9 rectifies the pulses from T1 pins 5 and 6 which result in approximately 19V DC at R29 input. R36 divides this voltage in half to protect and turn on the FET. When the FET turns on, it grounds U3-3 and R24 which allows the normal regulator feedback loop to operate and the output to produce 19V DC at the coaxial connector. When the output goes to 19V DC, D6 is reversed biased and /DET signal goes back to VCC which is now +5V.

When the AC is turned OFF because the device current went below the threshold (as will be explained in the following section), the coaxial output will turn off and Q3 FET will also turn off because of the lack of pulses from the transformer T1. This once again opens the voltage regulator loop. If the device is still connected to the coaxial plug, it will once again load R27 to ground and cause /DET to go low again. However, the MCU does not read the /DET line for about 5 seconds after turning the AC off. Also, it looks for a positive to zero transition to turn AC back on. This prevents the supply from cycling on and off. In order to turn AC power back on, the device needs to be unplugged and plugged back in. If it is left connected, the AC will remain off in zero power mode.

FIG. 6 shows the current monitor circuit. Before the power supply turns on, 5V will be off and U5 OPAMP will be powered off and will not draw any current from the coin cell battery due to the reverse bias of D8 section 1. Once the power supply is turned on and 5V is present, OPAMP (U5) is powered up. Current drawn by the device is measured as a voltage drop across R23 and R24. This voltage signal is amplified by U5A non-inverting amplifier and presented to the analog to digital converter (A/D) function of the MCU (U6 pin 1). If the current drawn from the 19V supply by the charging device falls below a predetermined threshold (e.g. 90 milliamps), for a predetermined time (e.g. 20 seconds), the MCU will set TON signal low, causing the AC power to turn off.

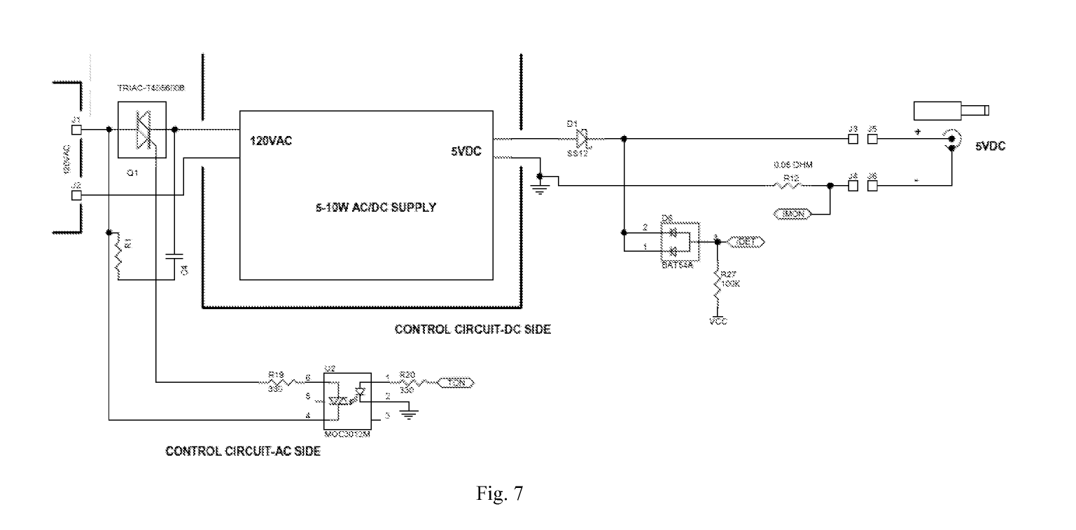

FIG. 7 shows an alternative embodiment of the AC adapter with automatic built-in power switch for the low wattage AC supply using primary side sensing. This embodiment is for application in low wattage AC supply versions such as 5 or 10 W. For low wattage AC supply, the basic supply design may not use an optical coupler based feedback regulator loop. Instead, it may use what is known as primary side sensing. To accomplish the detection function similar to the preceding embodiments, a Schottky diode rectifier (D1) is added to the output of the 5-10 W supply in series with the output line. When the AC power is off, D1 is reversed biased, the output DC line is pulled up to VCC (+3V) by R27, and the /DET line is high. When a device is connected to the coaxial plug, /DET goes low and the AC power is turned on as in the previous embodiment of the design. IMON is monitored by the MCU to turn off AC when the device current goes below a predetermined threshold.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An AC adapter with automatic built-in power switch comprising:
an AC power supply circuit,
an AC control circuit electrically connected to said AC power supply circuit to switch the AC power supply circuit on and off, and
a monitoring circuit to monitor the connection of the adapter to the power supply and to a device wherein said monitoring circuit comprises:
a standby power supply to provide power to the monitor circuit when the AC power supply is off,
a microcontroller,
a circuit for device detection, and
a current monitor circuit.

2. An AC adapter with automatic built in power switch as in claim 1 wherein said standby power supply is powered by a coin cell battery.

3. An AC adapter with automatic built in power switch as in claim 1 wherein said microcontroller is a microchip PIC 10F222.

4. An AC adapter with automatic built in power switch as in claim 1, further comprising a diode and a pull-up resistor and wherein a ground line is disconnected from said AC power supply circuit.

5. An AC adapter with automatic built in power switch as in claim 1 wherein said AC power supply circuit uses optical coupler based feedback regulator loop.

6. An AC adapter with automatic built-in power switch comprising:
an AC power supply means,
an AC control circuit means electrically connected to said AC power supply means to switch the AC power supply means on and off, and
a monitoring means to monitor the connection of the adapter to the power supply and to a device wherein said monitoring means comprises:
a standby power supply means to provide power to the monitor means when the AC power supply is off,
a microcontroller,
a means for device detection, and
a current monitor means.

7. An AC adapter with automatic built in power switch as in claim 6 wherein said standby power supply means is powered by a coin cell battery.

8. An AC adapter with automatic built in power switch as in claim 6 wherein said microcontroller is a microchip PIC10F222.

9. An AC adapter with automatic built in power switch as in claim 6, further comprising a diode and a pull-up resistor and wherein a ground line is disconnected from said AC power supply means.

10. An AC adapter with automatic built in power switch as in claim 6 wherein said AC power supply means uses optical coupler based feedback regulator loop.

11. An AC adapter with automatic built in power switch as in claim 6 wherein said AC power supply means uses primary side sensing.

12. An AC adapter with automatic built in power switch as in claim 11 wherein said AC power supply means comprises a Schottky diode rectifier in series with an output line.
